(19) United States
(12) Patent Application Publication
(10) Pub. No.: US 2025/0349054 A1
(43) Pub. Date: Nov. 13, 2025

(54) IMAGE EDITING THROUGH UTILIZATION OF LARGE LANGUAGE MODEL

(71) Applicant: GOOGLE LLC, Mountain View, CA (US)

(72) Inventors: Oscar Akerlund, Zurich (CH); Igor Petrovski, Zurich (CH); Agoston Weisz, Zurich (CH); Michael Andrew Goodman, Oakland, CA (US)

(21) Appl. No.: 19/201,494

(22) Filed: May 7, 2025

Related U.S. Application Data
(60) Provisional application No. 63/645,917, filed on May 12, 2024.

(51) Int. Cl. G06T 11/60; G06V 10/22

(52) U.S. Cl. CPC G06T 11/60; G06V 10/235

(57) ABSTRACT

Some implementations are directed to editing a source image based on a user request to edit the source image. The source image and the user request to edit the source image can be processed, using an image-editing system, to generate one or more image editing instructions. The one or more image editing instructions can indicate an image mask that edit (or preserves) one or more portions of the source image and/or can indicate a target object to be present in the edited image to replace a source object in the source image. Based on the one or more image editing instructions and source image, an edited image that shares the one or more portions with the source image and that differs from the source image by replacing the source object in the source image with the target object can be generated.

### BACKGROUND

The current large language models (LLMs) have shown phenomenal generative semantic and compositional power and have been trained on extremely large and diverse language datasets and/or language-image datasets. Some current LLMs, e.g., multimodal LLMs, are augmented with capabilities of understanding images and/or assisting in generating images. For example, some of the current LLMs can construct a text prompt based on a user query that requests to generate an image, where the text prompt can be processed using an image generation model (that is included in, or external to, the LLMs), to generate the image as the user query requests.

As another example, a user may provide a source image and a user query to generate a target image. In this case, the current LLMs often utilizes a description of the source image and the user query, to construct a text prompt. The text prompt is then processed, using an image generation model, to generate the target image as the user query requests. Such generated target image can include content (e.g., a background) conceptually similar to the source image and additional content (e.g., a target object to be present in the target image as required by the user query). However, the generated target image typically does not include the same or similar content (the same background) as the source image on a pixel level. In other words, the target image generated utilizing the current LLMs is a “new” image with respect to the source image, but not an “edited” version of the source image that retains certain content (e.g., the background) of the source image as the user desires.

Image editing is one of the most fundamental tasks in computer graphics, encompassing the process of modifying an input image through the use of an auxiliary input, such as a label, scribble, mask, or reference image. As described above, the current LLMs do not provide simple editing means for a given image, and generally lack control over specific semantic regions of the given image (e.g., using text guidance only). For example, even the slightest change in the textual prompt may lead to a completely different image being generated. For instance, changing a text prompt from “photo of yellow dog riding on a bicycle” to “photo of white dog riding on a bicycle” can result in a completely different generated image, such as one that changes the dog's shape, which can be undesired to a user.

### SUMMARY

Various implementations of the present disclosure are directed to editing a source image, using an LLM-based image editing system, to generate an edited image. The edited image can retain one or more portions of image content from the source image, and can include additional image content that is different from the source image and that is consistent with one or more edits to the source image. The one or more edits to the source image can be based on a user input that requests to edit the source image. The source image can be uploaded by a user, selected from an image database/source (e.g., a website), or generated using an image generation model, etc.

In some of the various implementations, the LLM-based image editing system can include a large language model (“LLM”) augmented with a capability of image understanding. In some implementations, the LLM-based image editing system can include an LLM, an image understanding model (e.g., a visual language model, an object recognition and classification model), and/or an image generation model. In some implementations, the LLM-based image editing system can include a multi-modal LLM. In some implementations, the LLM-based image editing system can include a multi-modal LLM and an image generation model. The LLM-based image editing system, however, is not limited to descriptions provided herein.

In some of the various implementations, an image mask can be automatically generated based on the user input that requests to edit the source image, to mask the one or more portions of the source image to be edited (or alternatively, to be preserved/retained in the edited image). In some of the various implementations, portion(s) of the source image that are not masked by the automatically generated image mask can be preserved and present in the edited image (e.g., at same positions as they are in the source image). This saves a human user significant time and effort by avoiding manually defining an accurate and precise image mask to edit desired region(s) or object(s) in the source image to generate the edited image that retains one or more aspects of image content from the source image. In other words, some of the various implementations do not require a user to specify a region of the source image that is to be edited, for target content (e.g., target object) to replace original content (e.g., original object) within the specified region.

In various implementations, the edited image can be visually similar to the source image, but includes visual modifications that are consistent with the user input. In doing so, various implementations can utilize one or more machine learning models (e.g., a visual language model and an LLM, a multi-modal LLM, etc.) to generate one or more image editing instructions. The one or more image editing instructions can include, for instance, an image mask (sometimes shortly as “mask”) identifying a portion of the source image to be edited to generate the edited image, without changing a location and content for other portion(s) of the source image. The one or more image editing instructions can additionally include a target object (or other target content) to be present in the edited image, where the target object replaces or modifies image content (e.g., a source object) at the identified portion of the source image.

In some of the various implementations, given a source image and user interface input (“user input”) that indicates one or more edits to the source image, the LLM-based image editing system can determine whether to generate a new image or edit the source image into the edited image. In some implementations, the LLM-based image editing system can determine whether the user interface input is correlated to the source image. If the LLM-based image editing system determines that the user interface input is correlated to the source image, the LLM-based image editing system can determine to edit the source image to generate the edited image.

There can be various manners in which the LLM-based image editing system determines whether the user interface input is correlated to the source image. For instance, the LLM-based image editing system can determine that the user interface input is correlated to the source image based on one or more terms from the user interface input identifying an object present in the source image. This can be implemented, for instance, by: recognizing or classifying objects present in the source image; and comparing the recognized objects with content of the user interface input, to determine whether the content of the user interface input includes or indicates any of the recognized objects. As another example, the LLM-based image editing system can determine that the user interface input is correlated to the source image based on an image embedding of the source image (e.g., an image showing a white dog riding a bike) and a text embedding of the user interface input that indicates desired content (e.g., a black dog) having a distance less than a predefined distance value in a latent space.

In some implementations, if the LLM-based image editing system determines that the user interface input is not correlated to the source image, the LLM-based image editing system can determine to generate a new image, instead of editing the source image to generate the edited image. For instance, the LLM-based image editing system can determine that the user interface input (e.g., “edit the image to show a bird over the sea”) is not correlated to the source image (e.g., an image showing a forest but no sea). In this case, while the user interface input includes a request to edit a given image, the LLM-based image editing system can still determine to generate a new image, without utilizing/editing the given image. For instance, instead of generating one or more image editing instructions, one or more image generation instructions can be generated and utilized to generate a new image. In this case, while the new image can be visually distinct from the new image (e.g., sharing no common image content), the new image can be consistent with the user interface input. By training model(s) included in the LLM-based image editing system to output image generation instruction(s) instead of image editing instruction(s) in situations where the source image and the user request to edit the source image is determined to be unrelated, significant computational resources associated with automatically generating image mask, etc., may be saved or reduced.

Various implementations provide a computer-implemented method implemented using one or more processors. The method can include: receiving an image (sometimes referred to as “source image”) and a user request to edit the image. The image can be uploaded by a user that provides the user request, can be an image identified from a link of a website, a photo captured using a camera, a synthetic image generated using a machine learning (ML) model, an image created using a drawing tool, etc. The present disclosure is not intended to be limiting.

In various implementations, the method can further include: processing, using a large language model system (e.g., the aforementioned LLM-based image editing system), and based on the image and the user request to edit the image, to generate one or more image editing instructions (or image editing parameters). The one or more image editing instructions can be, but does not necessarily need to be, in the form of a text prompt processable using an image generation model, where the text prompt can be, for instance, “using the source image to generate an edited image by changing image content within the bounding box that is generated for the source image and that has location information of [ . . . ] with a white cat, preserve image content outside the bounding box”.

The one or more image editing instructions, for example, can at least indicate a region of the image to be masked for editing (or alternatively, for image content preserving/retaining). In other words, the region of the image to be marked can be a region where image content within the region is to be edited (or a region where image content within the region is to be preserved and retained). Optionally, whether the region of the image to be masked is a region of the image to be edited or is a region of the image to be preserved can be based on the user request to edit the image. For example, the user request to edit the image can be: “change the background of the image from beach to grass”. In the example, the region of the image to be masked can be a region to be preserved and can be indicated, for instance, using a bounding box surrounding a target object (e.g., a tourist), where image content (e.g., the tourist) within the bounding box is to be preserved and image content (e.g., the background, e.g., beach) outside the bounding box is to be edited. As another example, the user request to edit the image can be: “add a rabbit in the grass”. In this example, the region of the image to be masked can be a region to be edited and can be indicated, for instance, using a bounding box surrounding a portion of the grass that is to be placed with a rabbit, where image content outside of the bounding box is preserved for inclusion in the edited image. Examples described herein, however, are not intended to be limiting.

The one or more image editing instructions can, additionally or alternatively, include or indicate an edit to the source image. The edit to the source image can be derived from the user request to edit the image. For example, the user request to edit the image can be a request to replace a source object in the image to be edited with a target object (e.g., “replace the dog with a white cat”). In this example, the edit to the source image (in the one or more image editing instructions) can be, for instance, “generate a white cat at a position of the region that is masked, and don't change other image content from the original image that is outside of the region that is masked”. As another example, the user request to edit the image can be a request to modify a characteristic (e.g., color, size, location, etc.) of a source object present in the source image, such as, “replace the color of the dog from black to white”. In this example, the edit to the source image can be, for instance, “change the color of the dog within the region that is masked from black to white”).

As a further example, the user request to edit the image can be a request to add/introduce a target object into the source image (e.g., “add a rabbit in the grass”), or remove source object from the source image (e.g., “delete the car in front of the Eiffel tower”). Corresponding, the edit to the source image (being part of the one or more image editing instructions) can be, for instance, “add a rabbit within the bounding box” or “replace the car with corresponding portion(s) of the Eiffel tower”. As an additional example, the user request to edit the image can be a request to modify a style of the source image (e.g., “make the photo of my pet into an oil painting”), or to transfer a style of an additional source image to the source image (e.g., “make the photo of my pet to have a style of this image)”. In the latter case, both the source image (e.g., a photo showing a pet of the user) and the additional source image (e.g., a line drawing showing a building) may need to be submitted or identified by the user that provides the user request. In this additional example, the edit to the source image (being part of the one or more image editing instructions) can be, for instance, “change the photo of my pet to an oil painting” or “make the photo of my pet a line drawing”.

The one or more image editing instructions can, additionally or alternatively, include a model selection instruction that identifies a particular image generation model (for processing of the one or more image editing instructions and/or the source image, to generate an edited image that shares certain image content with the source image). The particular image generation model can be specified in the user request to edit the image (i.e., “the source image”), or can be determined based on the user request to edit the image. For instance, based on the user request to edit the image being a request to modify a style of the source image, the one or more image editing instructions can include a model selection instruction that specifies an image generation model trained or fine-tuned to perform image style transfer and/or an address of such image generation model for image style transfer. As another example, based on the user request to edit the image being a request to remove a source object from the source image, the one or more image editing instructions can include a model selection instruction that specifies an image generation model trained or fine-tuned to replace the source image with image content consistent with a background of the source image. The examples described herein are, however, not intended to be limiting.

In various implementations, the method further includes: processing, using an image generation machine learning model, the one or more image editing instructions (or a prompt derived thereof) and the image (i.e., “source image”), to generate an edited image that is different from the received/source image. The edited image can include a portion of image content present in the source image (e.g., image content of the source image within or surrounding the region that has been masked) and include synthetic image content that is synthesized based on the user request to edit the source image and that is placed at a position determined based on the region that has been masked (e.g., within or surrounding the region that has been masked). The image generation machine learning model can be included in, or external to, the large language model system.

In some of the various implementations, processing, using the large language model system and based on the image and the user request to edit the image, to generate the one or more image editing instructions can include: generating a text description that describes the source image based on the source image and/or the user request to edit the source image, using an image understanding model of the large language model system; and processing, based on the text description that describes the source image and/or the user request to edit the source image, and using a text generation model (e.g., a large language model, “LLM”), to generate the one or more image editing instructions and/or a text reply to the user request to edit the source image. In some of the various implementations, the text description generated using the image generation can describe all objects present in the source image and include/indicate location information for all objects in the source image. In some of the various implementations, the text description generated using the image generation can describe a source object (or other source content) in the source image that is to be edited (e.g., replaced, removed, modified, etc.) based on the user request to edit and include/indicate location information for the source object (or other source content) in the source image.

The image understanding model can be, for instance, a classification model (e.g., an object recognition and classification model). In this case, generating the text description that describes the source image based on the source image and/or the user request to edit the source image, using the image understanding model can include: generating a text prompt based on the user request to edit the image, and processing the image and the text prompt, using the classification model, to generate the text representation of the image.

The image understanding model can be, for instance, an image captioning model (or other image understanding model, e.g., a YOLO model). In this case, a text prompt may not need to be generated based on the use request to edit the image. Correspondingly, generating the text description that describes the source image based on the source image and/or the user request to edit the source image, using the image understanding model can include: processing the image (and/or the user request to edit the image), using the image captioning model (or the YOLO model), to generate the text representation of the image.

The image understanding model can be, for instance, a visual language model. In this case, one or more text prompts can be generated. The one or more text prompts may be, but does not need to be, generated based on the user request to edit the image. In this case, generating the text description that describes the source image based on the source image and/or the user request to edit the source image, using the image understanding model can include: processing the image, using an image encoder of the visual language model, to generate an image embedding of the image (and/or the user request to edit the image); processing the one or more text prompts, using a text encoder of the visual language model, to generate one or more text embeddings each corresponding to one of the one or more text prompts; comparing the image embedding and the one or more text embeddings, respectively; generating a model output based on the comparing; and generating the text representation of the image based on the model output.

In some of the various implementations, optionally, the user request does not explicitly identify specific content of the image to be replaced with the additional content. In some of the various implementations, the edited image includes content within the region of the image that has been masked, or content outside of the region that has been masked. In some of the various implementations, the user request to edit the image/source image can be received via a chat interface of an application in communication with the large language model system. The user request to edit the image can be a typed user input, an audible user input, or other types of user input.

In various implementations, instead of or in addition to the aforementioned image understanding model and the text generation model, the large language model system can include a multi-modal large language model. A method for editing a source image can include: receiving a user request to edit an image; identifying the image based on the user request to edit the image; processing content based on the image and the user request to edit the image, using a multi-model large language model, to generate one or more image editing instructions (and/or a text reply responsive to the user request to edit the image); and generating, using an image generation model, an edited image based on the image and the one or more image editing instructions. The method can further include: causing the edited image and the text reply to be rendered in response to the user request to edit the image. Alternatively, the method can further include: generating a response based on the edited image and the text reply to be rendered in response to the user request to edit the image; and causing the generated response to be rendered (e.g., simultaneously) in response to the user request to edit the image.

In various implementations, the multi-modal large language model can be trained to output multi-modal model output. In this case, an additional method for editing an image can be provided. The additional method can include: processing, a textual user request to edit an image and the image, using a multi-model large language model, to generate a multi-modal model output from which an edited image and a text reply responsive to the user request to edit the image are derived; causing the edited image and the text reply to be rendered, in response to the user request to edit the image.

The preceding is presented as an overview of only some implementations disclosed herein. These and other implementations are disclosed in additional detail herein. For example, additional and/or alternative implementations are disclosed herein such as receiving more than one image and generating an edited image based on the more than one image. For instance, a further method can be provided, where the large language model system receives a first image, a second image, and a user request to edit the first image into an image style from the second image. This method can further include: processing the second image to determine the image style of the second image; generating one or more image editing instructions (and/or a text reply to the user request) based on the image style of the second image and based on processing the first image and the user request to edit the first image; generating an edited image based on the first image and the one or more image editing instructions, using an image generation model; and causing the edited image (and/or the text reply) to be rendered in response to the user request to edit the first image. The one or more image editing instructions can be generated using an image understanding model (e.g., as described above), a multi-modal large language model (e.g., as described above), or other applicable model(s). The present disclosure is not intended to be limiting.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B schematically depicts example components and interactions that can be involved in generating, using an LLM system, an edited image that is visually similar to a source image, but that includes visual modifications consistent with an edit request by a user to the source image.

FIG. 1C schematically depicts example components and interactions that can be involved in determining, using an LLM system, whether to generate a new image or to generate an edited image, in accordance with various aspects of the present disclosure.

FIG. 1D schematically depicts another example components and interactions that can be involved in generating, using an LLM system, an edited image that is visually similar to a source image, but that includes visual modifications consistent with an edit request by a user to the source image.

FIG. 1E schematically depicts another example components and interactions that can be involved in determining, using an LLM system, whether to generate a new image or to generate an edited image, in accordance with various aspects of the present disclosure.

FIG. 2A depicts a non-limiting example of a user interface receiving a user query and an image, in accordance with various aspects of the present disclosure.

FIG. 2B depicts a non-limiting user interface displaying an edited image in response to the user query, in accordance with various aspects of the present disclosure.

FIG. 2C depicts a non-limiting user interface displaying an image mask automatically generated using techniques described, in accordance with various aspects of the present disclosure.

FIG. 3A illustrates an example method of generating an edited image, in accordance with various implementations of the present disclosure.

FIG. 3B illustrates an example method of generating an edited image, in accordance with various implementations of the present disclosure.

FIG. 4 illustrates an example method 400 of training a multi-modal large language model, in accordance with various implementations of the present disclosure.

FIG. 5 schematically illustrates an example computer architecture on which selected aspects of the present disclosure can be implemented.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

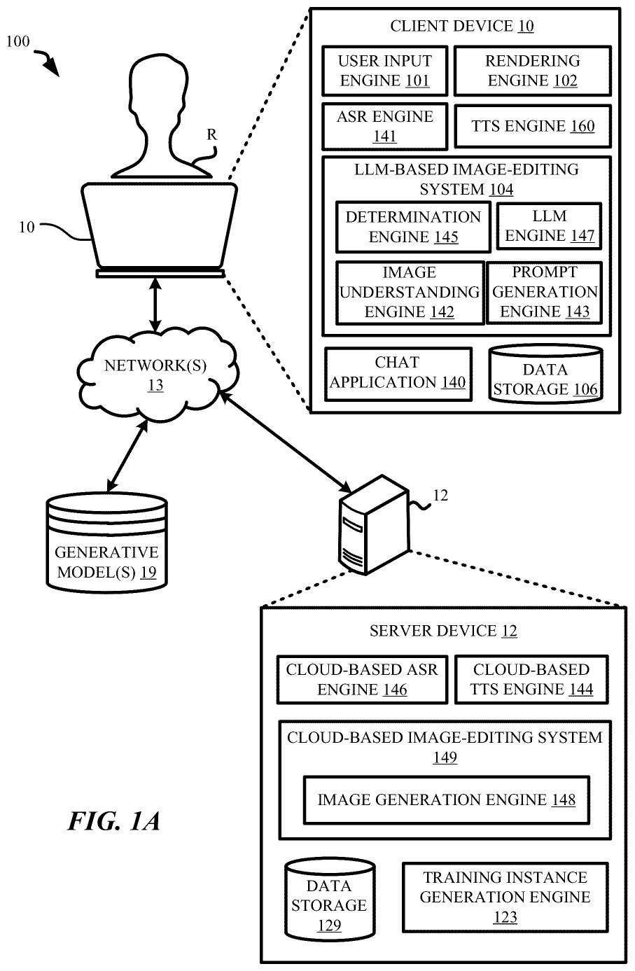

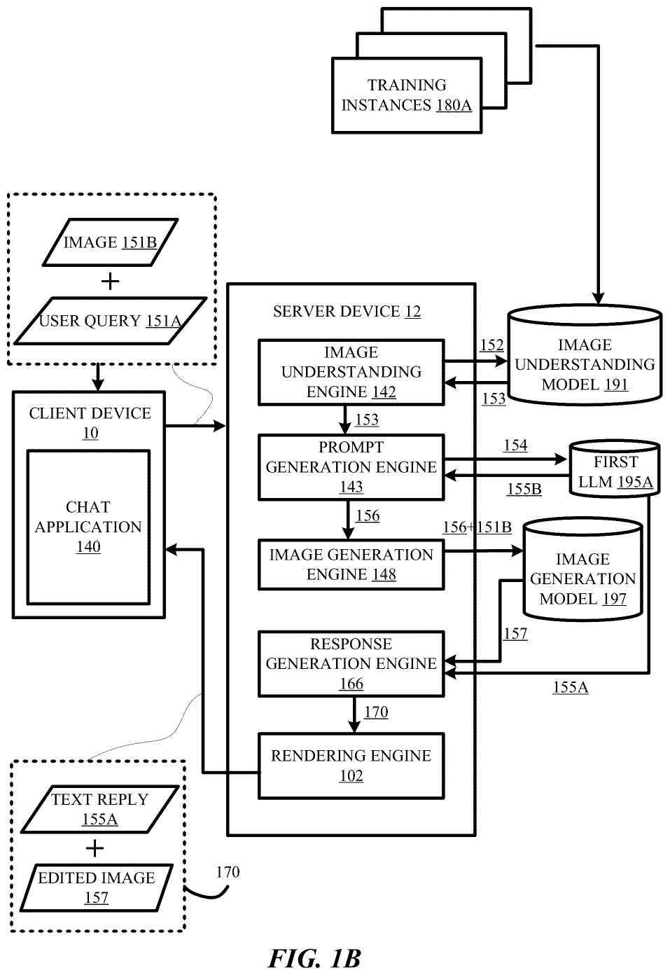

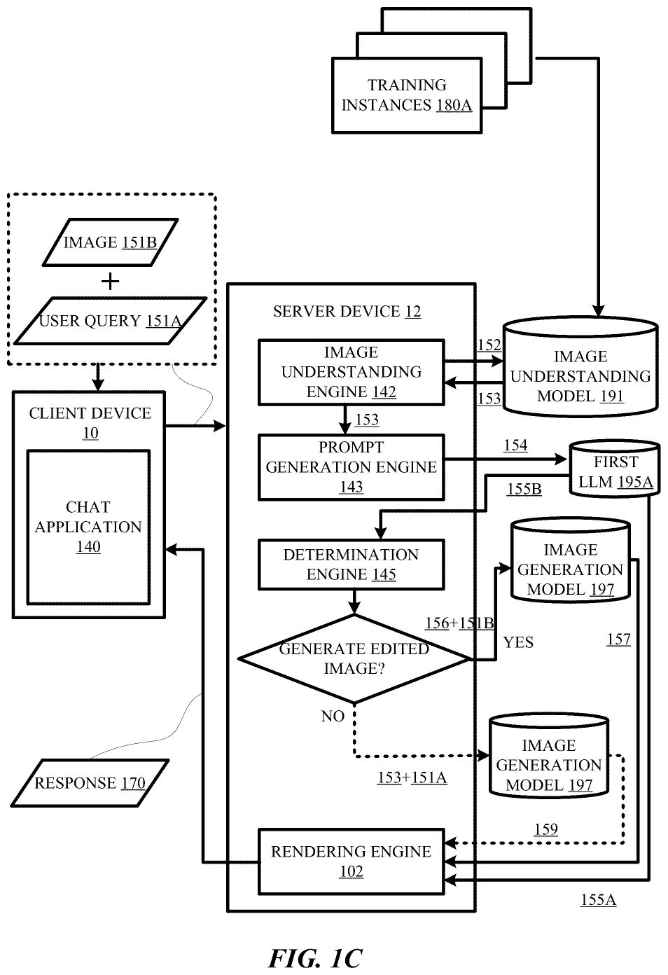

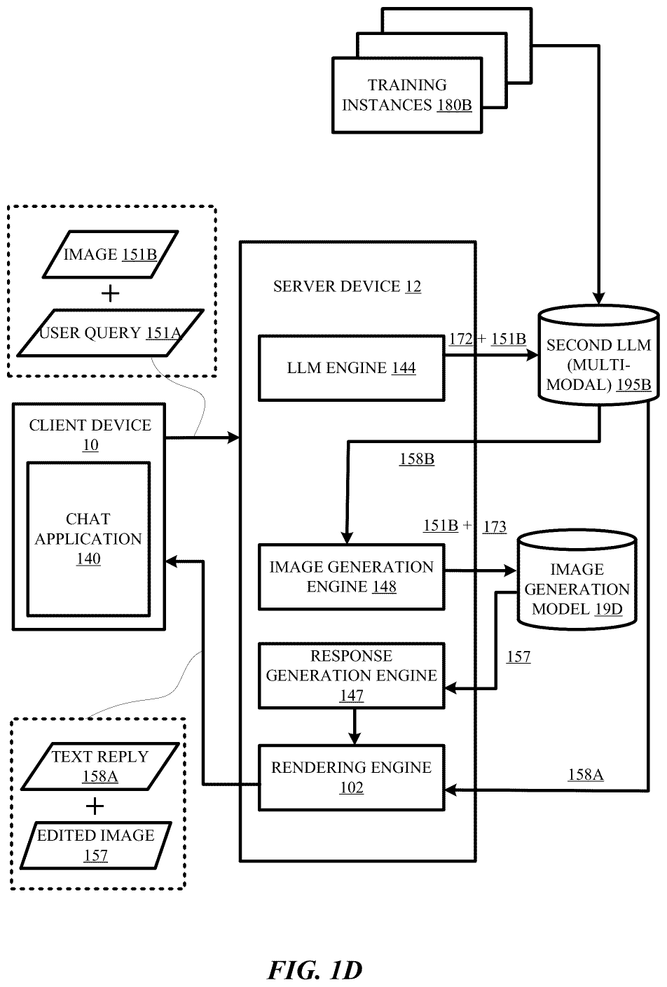

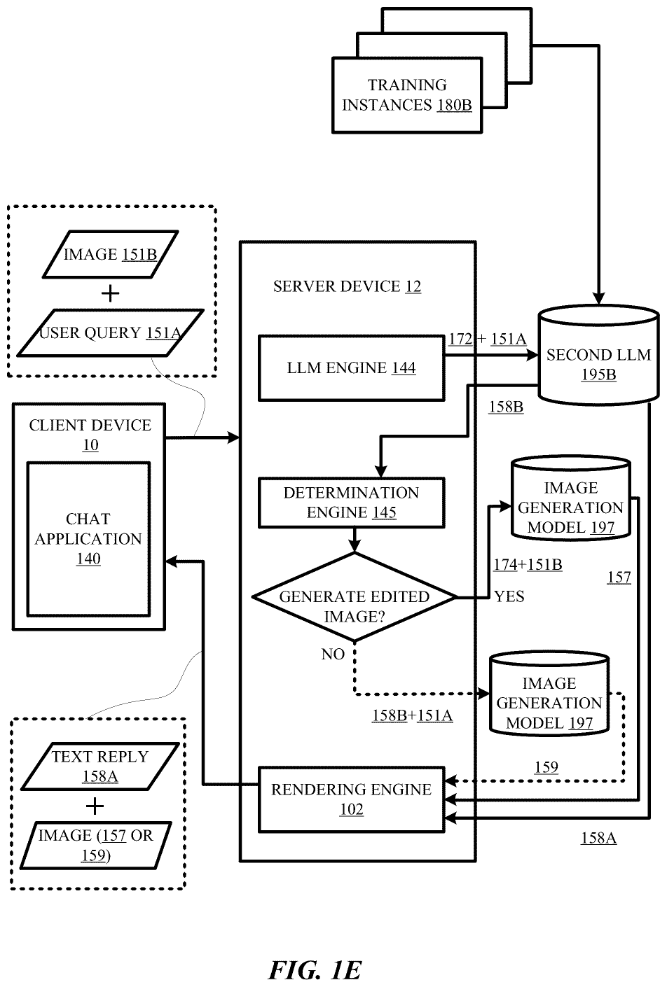

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) that is in communication with the client computing device 10 via one or more networks 13. The one or more networks 13 can include, for example, a local area network (LAN), a wide area network (WAN) such as the Internet, and/or any other appropriate network.

The client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

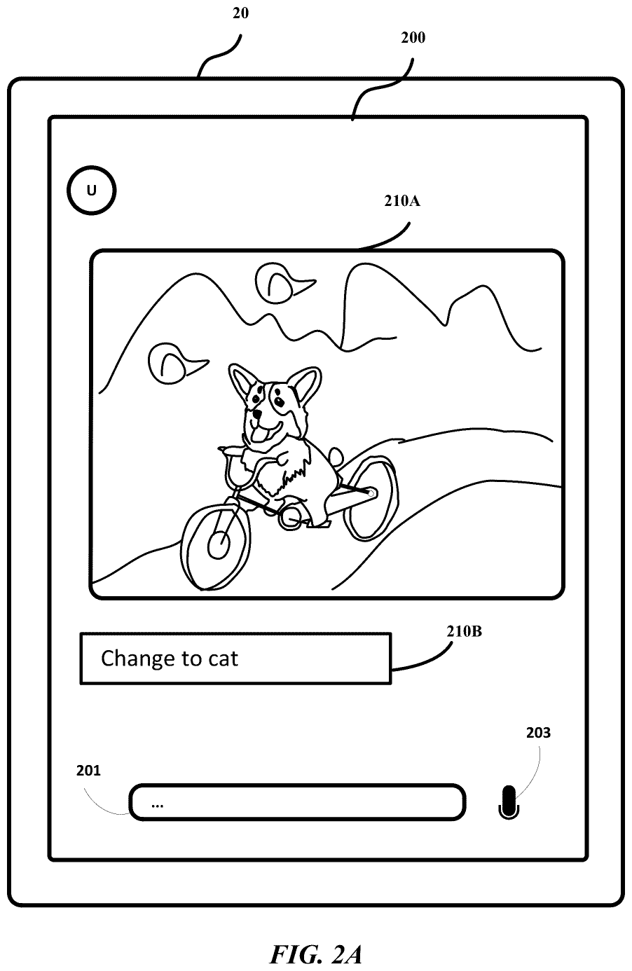

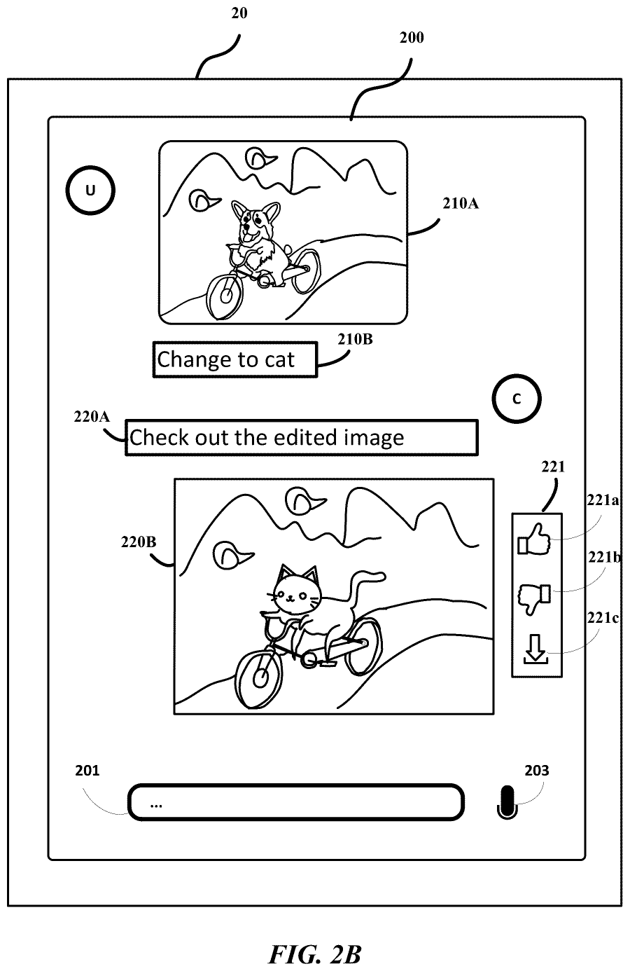

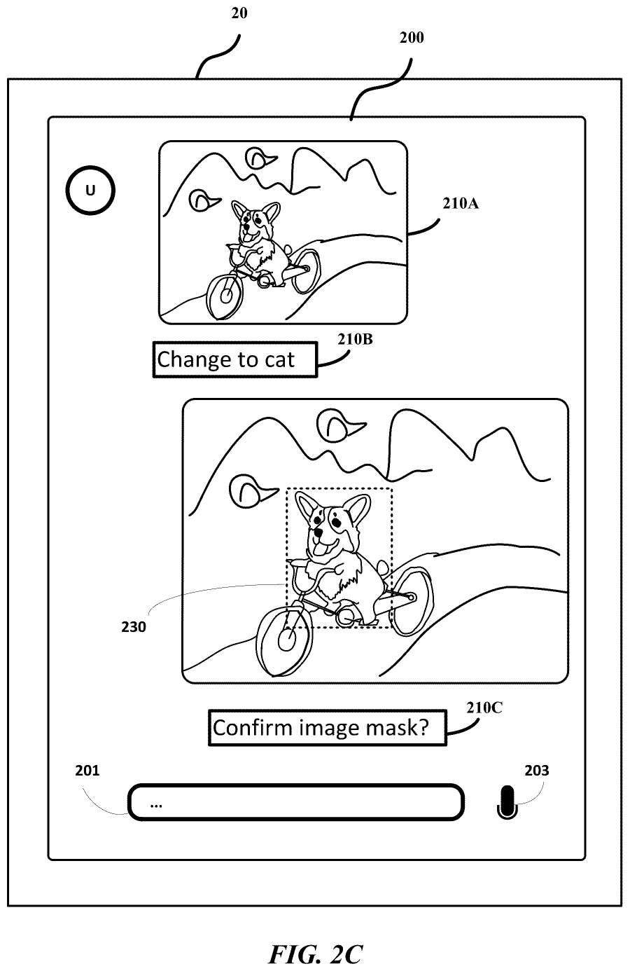

In various implementations, the client computing device 10 can include a user input engine 101 that is configured to detect user input provided by a user (e.g., user R) of the client computing device 10. The user input may be provided by the user using one or more user interface input devices, such as a keyboard, a touch screen, a microphone, etc. The user input can be typed input, touch input, audible input, or any other applicable type of input. For example, the client computing device 10 can be equipped with a keyboard to receive typed input, and/or a mouse (or one or more hardware buttons) to receive one or more user clicks. The one or more user clicks can select one or more graphical user interface (GUI) elements that is rendered visually at a user interface of the client computing device 10 to provide user input, and/or can select one or more files (e.g., images, documents, etc.) to be rendered, uploaded, transmitted, downloaded, deleted, etc. For instance, the one or more GUI elements can include a first GUI element (e.g., 201 in FIG. 2A) representing an input field to receive typed user input. Alternatively or additionally, the one or more GUI elements can include a second GUI element (e.g., 203 in FIG. 2A) to receive audible user input.

Additionally, or alternatively, the client computing device 10 can be equipped with one or more microphones that capture audio data, such as audio data capturing spoken utterances of the user and/or other sounds in an environment of the client computing device 10. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the client computing device 10 can include a rendering engine 102, one or more applications installed locally at (or otherwise accessible via) the client computing device 10, and/or a data storage 106. The one or more applications can include, for instance, a chat application 140. In various implementations, the rendering engine 102 can be configured to provide content for audible and/or visual presentation to a user of the client computing device 10 using one or more user interface output devices. For example, the client computing device 10 can be equipped with one or more speakers that enable content (e.g., “the edited image is ready, check it out”) to be provided for audible presentation to the user via the client computing device 10. Additionally, or alternatively, the client computing device 10 can be equipped with a display or projector that enables content (e.g., a source image and/or an edited image derived from the source image) to be provided for visual presentation to the user via, e.g., a user interface of the chat application 140 at the client computing device 10.

The data storage 106 at the client computing device 10, and/or a data storage 129 at the server device 12, can store various types of files and/or data. For instance, the data storage 106 can store metadata (e.g., a user profile of user R, etc.) associated with the one or more applications (e.g., the chat application 140) and/or associated with the client computing device 10. Additionally, or alternatively, in some implementations, the data storage 106 can store a plurality of training instances (e.g., 180A in FIG. 1B) to train or fine-tune machine learning (ML) model(s).

In various implementations, the chat application 140 can include, or otherwise access, an automatic speech recognition (ASR) engine 141 and/or a text-to-speech (TTS) engine 160. In various implementations, the ASR engine 141 can process, using one or more streaming ASR models (e.g., a recurrent neural network (RNN) model, a transformer model, and/or any other type of ML model capable of performing ASR), streams of audio data that capture spoken utterances (also referred to as “voice input”, “user speech”, etc.), to generate corresponding streams of ASR output. The ML model(s) can be on-device ML models that are stored locally at the client computing device 10, remote ML models that are executed remotely from the server computing device (e.g., at remote server device 12), or shared ML models that are accessible to the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 141 can select one or more of the ASR hypotheses as corresponding recognized text (“transcript”, “transcription”) that corresponds to the spoken utterance(s) (e.g., selected based on the corresponding predicted measures).

In various implementations, the TTS engine 160 can process, using TTS model(s), corresponding streams of textual content (e.g., content generated based at least on processing the recognized text using the LLM, or a predetermined text, etc.), to generate synthesized speech audio data that includes computer-generated synthesized speech. The synthesized speech audio data can be rendered audibly via one or more user interface output devices, such as a speaker. In additional or alternative implementations, the synthesized speech audio data can be pre-cached in memory or in one or more databases accessible by the client computing device 10.

In various implementations, the chat application 140 can include, or otherwise access, an LLM-based image-editing system 104 (may be referred to as a “large language model system”, “LLM system”, etc.). The LLM-based image-editing system 104 can include component(s) such as an image understanding engine 142, a prompt generation engine 143, and/or a determination engine 145. In some implementations, the image understanding engine 142 can be in communication with one or more machine learning (ML) models trained or fine-tuned for image understanding (“image understanding model”), such as a visual language model, an object detection & classification model, an image captioning model, a YOLO model, and/or a multi-modal LLM, etc. For example, the image understanding engine 142 can process a source image, and/or a user query (or instead of the user query, a first text prompt derived from the user query), using the visual language model and/or the object detection & classification model, to generate a text representation of the source image.

For instance, the source image can be a painting (or a photo uploaded by a user from an electronic album) showing a white butterfly sitting on top of a native pink milkweed. The user query can include or indicate one or more edits to the source image. In some implementations, the user query can, but does not necessarily need to, identify one or more source objects in the source image to be edited or modified. In some implementations, additionally or alternatively, the user query can include or indicate a target object to be generated in the edited image based on modifying or replacing one of the one or more source objects (or other image content) in the source image. In some implementations, additionally or alternatively, the user query can include or indicate a modification or edit to a property (e.g., color, size, shape, etc.) of a source object/image content in the source image. Descriptions of the user query, however, are not limited herein. In some implementations, the aforementioned first text prompt (to be processed, along with the source image, by the image understanding engine 142) can include, for instance, a first instruction to identify a location of source object(s) in the source image based on the user query. It is noted that the image understanding model can be trained so that the first text prompt does not need to be generated. In other words, an image understanding model can be trained to process an image (and/or the user request to edit, which can be called “edit request”), to generate a text representation/description of the image.

As a working example, given the source image showing a white butterfly sitting on top of a native pink milkweed, the user query can be “change color of the butterfly to orange” which identifies a source object (e.g., “butterfly”) and an edit (e.g., “change color . . . to orange”) to the source object. The user query can also be, for instance, “change the butterfly to a monarch butterfly” which identifies the source object (e.g., “butterfly” which can refer to the white butterfly sitting on top of the native pink milkweed) and a target object (e.g., “monarch butterfly”) that is to replace the source object to sit on top of the native pink milkweed. Optionally, the user query can also be, for instance, “change to a monarch butterfly” which does not explicitly identify the source object (e.g., “white butterfly”) to be edited in the source image, but identifies a target object to be introduced into the source image, to generate an edited image that shares certain image content (e.g., an image background such as the pink milkweed plant) with the source image and that includes additional image content generated based on the user query. In some implementations, it is noted that, depending on one or more factors (correlation between the source image and the user query, a degree of image edit, etc.), a new image can be generated without using the source image, instead of the edited image which is generated utilizing the source image. For instance,

In the above working example, the image understanding engine 142 can process the source image and/or the user query, to generate a text representation of the source image. The text representation of the source image can, for instance, include a description of image content of the source image (e.g., a white butterfly sitting on top of a native pink milkweed, or a more detailed description). The text representation of the source image can further indicate, for instance, a position (e.g., positions of pixels) of a source object (which may be identified based on the user query) to be edited (e.g., modified to have a different property such as color, or replaced with a target object). In some implementations, as described above, the user query may identify a target object (e.g., monarch butterfly) but not a source object in the source image to be replaced with the target object. In this case, the image understanding engine 142 can process the source image to determine whether any object (e.g., white butterfly, pink milkweed, etc.) recognized in the source image is associated with (e.g., belongs to the same category as) the target object (e.g., monarch butterfly).

In response to determining that a particular object (e.g., white butterfly) is determined to belong to the same category as the target object (e.g., monarch butterfly), the image understanding engine 142 can determine the particular object as the source object to be edited in the source image and/or determine locations or pixels corresponding to the particular object. Optionally, in some implementations, in response to the image understanding engine 142 determining no object recognized from the source image is associated with the target object (e.g., monarch butterfly) identified in the user query and/or the user query not being a request to add image content (e.g., not a request like “add monarch butterfly”), the determination engine 145 can determine to generate a new image utilizing the user query and/or the text representation of the source image (e.g., without utilizing the source image itself which shows a white butterfly sitting on top of a pink milkweed), instead of editing the image to generate an edited image.

In various implementations, optionally, the prompt generation engine 143 can generate a second text prompt based on the text representation of the source image, where the second text prompt can be provided to a large language model (“LLM”) in communication with the prompt generation engine 143. The second text prompt based on the text representation of the source image can include an instruction to generate image editing instructions or parameters, and such second text prompt can be processed, using the LLM, to generate one or more image editing instructions. Optionally, the second text prompt can include an additional instruction to generate a text reply responsive to the user query, in addition to the text representation of the source image. In this case, the second text prompt can be processed, using the LLM, to generate the one or more image editing instructions and a text reply responsive to the user query.

The aforementioned LLM can be, for instance, a text generation LLM, or a multi-modal LLM. In some implementations, the LLM can be trained or fine-tuned, so that the second text prompt needs not be generated. In other words, the text representation of the source image (and/or the user query) can be processed as input, using the LLM, to generate the one or more image editing instructions (and/or the text reply).

Continuing with the working example above, the text reply responsive to the user query of “change color of butterfly to orange” can be, for instance, “the photo is edited to show an orange butterfly, check it out below”, or can include any other appropriate content. In this working example, the one or more image editing instructions can indicate an image mask to edit image content from the source image which shows white butterfly sitting on top of the pink milkweed so that such image content outside of the image mask will not be edited or modified during generation of the edited image. In some implementations, however, the image mask can alternatively mask image content to be preserved or retained. The one or more image editing instructions can, additionally or alternatively, indicate the target object (e.g., monarch butterfly) to replace the source object (e.g., white butterfly), or a property (e.g., color, shape, etc.) of the source object in the source image to be edited or modified.

Optionally, as described previously, the one or more image editing instructions can indicate a specific image generation model to be utilized to generate the edited image. Optionally, the one or more image editing instructions can indicate whether to generate an edited image utilizing the source image or to generate a new image not utilizing the source image. Descriptions of the one or more image editing instructions are limited herein.

In some implementations, optionally, the source image and the one or more image editing instructions can be provided to an image generation engine 148. The source image and the one or more image editing instructions can be processed as input, using an image generation model that the image generation engine 148 is in communication with, to generate an edited image showing one or more edits to the source image in accordance to the user query. The image generation model can be, or can include, for instance, one or more machine learning models. In some implementations, the image generation model can be selected from a set of image generation models that the image generation engine 148 accesses, for instance, based on the user query to edit (which may be a request to change image style into an oil painting) or metadata (e.g., chat history, application data, etc., that indicates the source image is generated using a particular image generation model) associated with the user query.

Continuing with the working example above, the source image can show a white butterfly sitting on top of a pink milkweed, and the edited image can show an orange butterfly sitting on top of exactly the same pink milkweed if the user query is to change white color of the butterfly to orange color. The edited image can also, for instance, show a monarch butterfly sitting on top of exactly the same pink milkweed if the user query is, for instance, “change white butterfly to monarch butterfly” or “change to monarch butterfly”. The edited image can also, for instance, show a bird sitting on top of exactly the same pink milkweed if the user query is, for instance, “change butterfly to bird”.

In some implementations, optionally, the one or more image editing instructions (and/or the source image) can be provided to the determination engine 145 before being provided to the image generation engine 148, where the determination engine 145 determines whether to edit the source image to generate an edited image utilizing bytes or pixels of the source image, or to generate a new image without utilizing bytes of the source image provided. In response to the determination engine 145 determining to edit the source image, the source image and the one or more image editing instructions (or an edit query, or text prompt, derived therefrom), can be provided to an image generation model. The source image and the one or more image editing instructions can be processed, using the image generation model, to generate the edited image. Or, the source image and the edit query (derived from the one or more image editing instructions) can be processed, using the image generation model, to generate the edited image.

In response to the determination engine 145 determining to generate the new image, the one or more image-editing instructions (or the edit query derived from the one or more image editing instructions) and/or the text representation of the source image can be provided to the image generation model. The one or more image-editing instructions (or the edit query derived therefrom) and/or the text representation of the source image can be processed, using the image generation model, to generate a new image. It is noted that, while the edited image shares certain content with the source image, the new image may not share image content with the source image as seeds utilized by the image generation model may be randomly selected/used. In other words, the edited image may be much more visually similar to the source image than the new image.

In various implementations, the text reply and the edited image (or the new image) can be rendered to a user that provides the user query and/or the image, in response to the user query.

In some implementations, alternatively or additionally, the LLM-based image-editing system 104 can include an LLM engine 147. The LLM engine 147 can be in communication with a multi-modal LLM. The user query and the source image can be processed as input, using the multi-modal LLM, to generate a model output from which the one or more image editing instructions (and/or the text reply) as described above are generated. The source image and the one or more image editing instructions can be provided to an image generation model, to generate a model output from which an edited image showing one or more edits to the source image can be generated.

While the ASR engine 141, the TTS engine 160, the image understanding engine 142, the prompt generation engine 143, the determination engine 145, and the LLM engine 147 are depicted in FIG. 1A as being included in the client computing device 10, one or more of these engines can be included (or have a counterpart) in the server computing device 12. For instance, as shown in FIG. 1A, the server computing device 12 can include a cloud-based ASR engine 146 and/or a cloud-based TTS engine 144. In some implementations, the server computing device 12 can include a cloud-based image-editing system 149 having the same or similar components of the LLM-based image-editing system 104. While the image generation engine 148 is depicted in FIG. 1A as being included in the cloud-based image-editing system 149, the image generation engine 148 can be included, or can have a counterpart, in the client computing device 10. The server computing device 12 can be, for example, a web server, one or more blade servers acting together to provide “cloud” infrastructure, or any other type of server as needed.

In some implementations, the server computing device 12 can include a training instance generation engine 123 that generate one or more training instances, to train or fine-tune one or more machine learning models (e.g., generative model(s) 19) that are in communication with the client computing device 10 and/or the server computing device 12. The one or more training instances can include, for instance, a first set of training instances to train or fine-tune the aforementioned LLM (e.g., trained for text generation), a second set of training instances to train or fine-tune the aforementioned multi-modal LLM, and/or a third set of training instances to train the aforementioned image-generation model, etc. For instance, the multi-modal LLM can be fine-tuned to process an image and a user query (to edit the image) as input, to generate a multi-modal LLM output. Based on multi-modal LLM output, a text reply to the user query and/or one or more image-editing instructions (as described above) can be derived. Alternatively, the multi-model LLM output can correspond to multi-modal content. For instance, the multi-modal LLM can be so trained or fine-tuned to generate the multi-model LLM output from which a text reply to the user query and an edited image can be derived.

FIG. 1B schematically depicts an example of components and interactions that can be involved in generating, using an LLM system (e.g., LLM-based image-editing system 104 in FIG. 1A), an edited image that is visually similar to a source image, but that includes visual modifications consistent with an edit request by a user to the source image. As shown in FIG. 1B, a user can provide a user query 151A with respect to an image 151B (e.g., a photo showing a lawn with a dogwood tree in the middle of the lawn, which can be captured using a camera, a hand-drawn image, or a computer-synthesized drawing) to the chat application 140 installed at, or accessible via, the client device 10. The user query 151A can be, for instance, a request to edit the image 151B, such as “add a dog to the grass”, “delete the tree in the grass”, “change to a maple tree”, etc. The image 151B can be, for instance, uploaded by the user from a local folder at the client device, an image from the Internet, an image generated using an image generator (e.g., in communication with the image generation model), or any applicable image.

In some implementations, the user query 151A and the image 151B can be provided to the LLM-based image-editing system 104. In some implementations, the LLM-based image-editing system 104 can be accessed at the server device 12, and the user query 151A and the image 151B can be transmitted to the server device 12. As shown in FIG. 1B, in some implementations, the LLM-based image-editing system 104 can include the image understanding engine 142, and the prompt generation engine 143.

As a non-limiting example, the user query 151A can be, “change to a maple tree”, and the image 151B can show “a lawn with a dogwood tree in the middle of the lawn”. In this non-limiting example, the user would be expecting to see an edited image showing the same lawn as the image 151B, with the dogwood tree in the middle of the lawn replaced with a maple tree. In other words, the user would be expecting the edited image to be visually similar to the image 151B, except for image content to be added into, deleted from, or modified in the image 151B, as requested by the user query 151A.

In some implementations, referring to FIG. 1B, the user query 151A (i.e., “change to a maple tree”) and the image 151B (i.e., which shows a lawn with a dogwood tree in the middle of the lawn) can be received at the client device 10. The user query 151A and the image 151B can be received at the client device 10 simultaneously or not simultaneously. For instance, a user can first submit the image 151B to the chat application 140 and subsequently provide the user query 151A. The user can also first submit the user query 151A and subsequently upload the image 151B. The user can also select the image 151B and type in the user query 151A, and submit the image 151B and the user query 151A to the chat application by pressing an “enter” key. The specific manners and order of submitting the user query 151A and the image 151B are not limited to descriptions herein. For instance, the image 151B may be generated using an image generation model based on a user request to generate an image (e.g., “generate an image showing a dogwood in the middle of a lawn”), and be rendered to the user via the chat application 140. In this case, the user may want to edit the generated image, and therefore provide the user query 151A which says “change to a maple tree in the previously generated image”. In some implementations, the user query 151A and/or the image 151B can be transmitted to the server device 12 for further processing.

For example, in some implementations, as shown in FIG. 1B, the image 151B can be provided to the image understanding engine 142 in communication with an image understanding model 191, along with (or sometimes without) a first text prompt that instructs the image understanding model 191 to understand the image 151B (e.g., generate a text description/representation of the image 151B). The first text prompt can additionally, or alternatively, include an instruction to identify a source object (or source content, or source area) of the image 151B to be edited (e.g., deleted, modified, added) and/or a position of the source object (or source content/area), in the text description. In some implementations, optionally, the source object (or source content) can be identified based on processing the user query 151A and/or the image 151B. In some implementations, the image understanding model 191 can be fine-tuned using one or more training instances 180A, so that the first text prompt no longer needs to be provided to the image understanding model 191. In some implementations, the first text prompt can be generated, e.g., using the prompt generation engine 143.

The image 151B and/or the first text prompt can be processed as input 152, using the image understanding model 191, to generate a text representation 153 of the image 151B. In some implementations, the first text prompt can be, but does not always need to be, derived based on the user query 151A. For example, the first text prompt can be, for instance, “generate a description of the provided image” or “generate a description of the provided image and identify positions of all objects recognized in the provided image”. In some implementations, the first text prompt can be derived based on the user query 151A. For example, given the user query 151A being “change cat to dog”, the first text prompt can be, for instance, “generate a description of the image, add a bounding box for cat in the image if there is any”.

Continuing with the non-limiting example above, the text representation 153 of the image 151B can be, for instance, “This image depicts a lawn with a dogwood tree in the middle of the lawn.” In some implementations, the text representation 153 of the image 151B can further indicate location information for one or more objects (e.g., location of the boundary of the lawn, location of boundary of the dogwood tree, etc.) in the image 151B. In some implementations, the location information for the one or more objects can be applied to generate one or more image masks for subsequent use in generating an edited image or a new image, so that pixel values of certain pixels of the image 151B that correspond to image content of the image to be covered by the one or more image masks can be preserved (i.e., not being modified) and be included in the edited image (or the new image).

The image understanding model 191 can be, for instance, an image captioning model, an objection detection and classification model, a visual language model, a YOLO model, or any other machine learning (ML) model trained or fine-tuned for image understanding.

In some implementations, a second text prompt 154 can be generated, e.g., using the prompt generation engine 143, based on the text representation 153 (of the image 151B) and/or the user query 151A. The second text prompt 154 can be provided to a first LLM 195A, where the second text prompt 154 is processed as input, using the first LLM 195A, to generate an LLM output. The first LLM 195A can be, for instance, a large language model trained or fine-tuned for text generation. From the LLM output of the first LLM 195A, a text reply 155A and/or one or more image editing instructions 155B can be derived.

Continuing with the working example above, the second text prompt 154 can be, for instance, “generate a text reply to the user request and generate image editing instructions based on the following image description and user request”. The text reply 155A can be responsive to the user query 151A, and can be, for instance, “Image has been edited per your instruction, check it out below” or “the dogwood tree has been replaced with the maple tree, see below the edited image”, etc. The one or more image editing instructions 155B can be, for instance, “mask the provided image using a bounding box that surrounds the dogwood tree, replace the dogwood tree with maple tree”.

In some implementations, the image 151B and/or an edit query 156 can be provided to an image generation model 197, where the edit query 156 can be generated by the image generation engine 148 based on the one or more image editing instructions 155B. The image 151B and/or the edit query 156 can be processed as input, using the image generation model 197, to generate an edited image 157. The edited image 157 and/or the text reply 155A can be rendered responsive to the user query 151A, via the client device 10. For instance, in some implementations, the edited image 157 and/or the text reply 155A can be provided to the rendering engine 102, where the rendering engine 102 causes the edited image 157 and the text reply 155A to be rendered at a user interface of the chat application 140, in response to the user query 151A.

In some implementations, referring to FIG. 1B, the edited image 157 and/or the text reply 155A can be provided to a response generation engine 166, where the response generation engine 166 can generate a response 170 to the user query 151A based on the edited image 157 and the text reply 155A. The rendering engine 102 can cause the response to be rendered via the chat application 140, in response to the user query 151A. The response 170 can include the edited image 157. Optionally, the response 170 can include the text reply 155A, or a variation of the text reply 155A. Optionally, the response 170 can include additional content that is in addition to the edited image 157 and the text reply 155A (or a modified version thereof). For instance, the response 170 can include one or more graphical user interface (GUI) elements to receive user feedback (positive, negative, neutral, etc.) towards the edited image 157. The edited image 157, the user feedback received for the edited image 157, the image 151B, and the user query 151B, may be utilized to generate a training instance using the training instance generation engine 123.

The response 170 can, additionally, or alternatively, include one or more additional GUI elements that enable a user to perform one or more actions (e.g., download, copy, etc.) with respect to the edited image 157. In some implementations, optionally, the one or more additional GUI elements can include an image mask modification tool that can be selected to show the automatically generated image mask (which can mask a region of the image 151B to be edited or preserved). Optionally, the image mask modification tool can be selected to enable the user to modify the automatically generated image mask, or create a new image mask, etc.

Optionally, referring to FIG. 1C, in some implementations, the image 151B (and/or the text representation 153 thereof) and the one or more image editing instructions 155B generated using the first LLM 195A can be provided to the determination engine 145, for determining whether to edit the image 151B or to generate a new image. In some implementations, instead of the one or more image editing instructions 155B, one or more image processing instructions can be generated, where the one or more image processing instructions can either include a set of image editing instructions or a set of image generation instructions. In this case, the one or more image processing instructions can be provided to the determination engine 145. The one or more image processing instructions can be generated, for instance, using the first LLM 195A (or other models) based on the prompt 154 of, e.g., “here is [user query] and here is description of current image [description of image]. If the user query seeks to edit the current image output an instruction for editing the current image. If the user query instead seeks to create a new image, or can not appropriately edit the current image, output an instruction for generating a new image based on the user query.” Based on (and sometimes only on) the one or more image processing instructions (e.g., whether the one or more image processing instructions include image editing instruction or image generation instruction), the determination engine 145 determines whether to edit the image 151B to generate an edited image, or to generate a new image without utilizing bytes of the image 151B provided. In response to the determination engine 145 determining to edit the image, the image 151B and the edit query 156 derived from the one or more image editing instructions 155B can be provided to the image generation model 197. The image 151B and the edit query 156 can be processed, using the image generation model 197, to generate the edited image 157.

Continuing with the working example above, the edited image 157 can show a lawn with a maple tree in the middle of the lawn, where the edited image 157 is an edited version of the image 151B (e.g., showing a lawn with a dogwood tree in the middle of the lawn). In other words, the edited image 157 and the image 151B can share the same image content with respect to a large portion of the lawn, while the edited image 157 differs from the 151B by having a maple tree instead of a dogwood tree in the middle of the lawn, as the user requests in the user query 151A (e.g., “change to a maple tree”).

In response to the determination engine 145 determining to not generate the edited image (e.g., determining to generate a new image), the edit query 156 (or the one or more image editing instructions 155B) and/or the text representation 153 (“a lawn with a dogwood tree in the middle of the lawn”) can be provided to the image generation model 197. The edit query 156 (or the one or more image editing instructions 155B) and/or the text representation 153 can be processed, using the image generation model 197, to generate the new image 159. The new image 159, different from the edited image 157, may not be visually similar to any portion of the image 151B.

Depending on whether the edited image 157 or the new image 159 is generated, the response 170 can include the text reply 1551A and the edited image 157 (or the new image 159). The response 170 can be rendered in response to the user query 151A. It is noted that, features in FIG. 1C the same as, or similar to, that in FIG. 1B are not repeatedly described herein, for the sake of brevity.

Optionally, in some implementations, determining whether to generate an edited image or a new image can occur based on comparing the user query 151A and the text representation 153 of the image 151B. The present disclosure is not limited thereto.

FIG. 1D schematically depicts another example of components and interactions that can be involved in generating, using an LLM system, an edited image that is visually similar to a source image, but that includes visual modifications consistent with an edit request by a user to the source image. As shown in FIG. 1D, in some implementations, the LLM-based image-editing system 104 can include the LLM engine 144. The LLM engine 144 can be accessed at the client device 10 and/or at the server device 12. In some implementations, a text prompt 172 derived from the user query 151A, aa well as the image 151B, can be processed as input, by the LLM engine 144 and using a second LLM 195B that is in communication with the LLM engine 147, to generate a multi-modal LLM output. Based on the multi-modal LLM output, a text reply 158A and one or more image editing instructions 158B can be generated. The second LLM 195B can be, for instance, a multi-modal LLM. The multi-modal LLM can be trained to process multi-modal content as input, and/or generate a corresponding model output from which text content (or multi-modal content) can be derived.

The image 151B and an edit query 173 derived from the one or more image editing instructions 158B can be processed as input, using the image generation model 197, to generate a model output from which the edited image 157 can be derived. The edited image 157 can be rendered to a user of the user query 151A, along with the text reply 158A, in response to the user query 151A.

In some implementations, the multi-modal LLM 195B can be fine-tuned using one or more training instances 180B, to generate the one or more image editing instructions 158B and/or the text reply 158A. The image 151B and the one or more image editing instructions 158B can be processed as input, using the image generation model 197, to generate a model output from which the edited image 157 can be derived. In some implementations, the multi-modal LLM 195B can be trained or fine-tuned in a supervised manner, or via reinforcement learning via human feedback (RLHF).

Optionally, referring to FIG. 1E, in some implementations, the image 151B and the one or more image editing instructions 158B generated by the LLM engine 147 using the multi-modal LLM 195B can be provided to the determination engine 145, where the determination engine 145 determines whether to edit the image to generate an edited image 157, or to generate a new image 159 without utilizing bytes of the image 151B provided. In response to the determination engine 145 determining to edit the image, the image 151B and an edit query 174 derived from the one or more image editing instructions 158B can be provided to the image generation model 197. The image 151B and the edit query 174 can be processed, using the image generation model 197, to generate the edited image 157.

In response to the determination engine 145 determining to generate the new image 159, the edit query 174, the one or more image editing instructions 158B, and/or the user query 151A can be provided to the image generation model 197. For instance, the edit query 174, the one or more image editing instructions 158B, and/or the user query 151A can be processed as input, using the image generation model 197, to generate the new image 159.

FIG. 2A depicts a non-limiting example of a user interface receiving a user query and an image, in accordance with various aspects of the present disclosure. FIG. 2B depicts a non-limiting user interface displaying an edited image in response to the user query, in accordance with various aspects of the present disclosure. As shown in FIG. 2A, a user (e.g., user U) can upload, via a user interface 200, an image 210A. The user interface 200 can be of a client device 20, or can be of a chat application installed at, or accessible via, the client device 20. The user can provide a user input 210B requesting one or more image edits to the image 210A.

In some implementations, the user can submit, simultaneously, the image 210A and the user input 210B requesting one or more image edits to the image 210A, to the client device 20. In some implementations, the user can submit the image 210A to the client device 20, prior to the user input 210B requesting one or more image edits to the image 210A. In some implementations, the user can submit the image 210A to the client device 20, subsequent to the user input 210B requesting one or more image edits to the image 210A. The user input 210B can be submitted by the user via typed input, audible input, or other types of user input. In some implementations, the user can submit the user input 210B, for instance, by clicking a submission button. In this case, clicking the submission button may automatically trigger the image 210A (if received prior to the user input 210B) and the user input 210B to be transmitted to an image-editing system (e.g., the cloud-based image-editing system 149) to generate an edited image (and in some implementations, a new image) visually similar to the image 210A. In some implementations, submission of the image 210A can trigger the user input 210B (if submitted prior to the image 210A) and the image 210A to be transmitted to the image-editing system.

As a non-limiting example, referring to FIG. 2A, the image 210A can show a dog riding a bike in a country road with (or without) background such as mountains and/or clouds. In some implementations, the user input 210B requesting one or more image edits to the image 210A can identify a source object (e.g., dog) in the image 210A to be replaced with a target object (e.g., cat). For instance, the user input 210B can be: “change dog to cat”. In some implementations, the user input 210B requesting one or more image edits to the image 210A can identify the target object (e.g., cat), without identifying the source object (e.g., dog) in the image 210A that is to be replaced with the target object. For instance, as shown in FIG. 2A, the user input 210B can be: “change to cat”. In this case, the image-editing system can determine the source object (e.g., dog) in the image 210A to be replaced with the target object (e.g., cat). For instance, the image-editing system can determine the source object (e.g., dog) in the image 210A by: classifying object(s) present in the image 210A (e.g., using the visual language model 190 191 or an object recognition and classification model); and determining a particular object as the source object based on the particular object and the target object belonging to the same or similar classification/category (e.g., animal, or living life, etc.).

In some implementations, referring to FIG. 2A, the image 210A and the user input 210B requesting one or more image edits to the image 210A (or a first prompt derived from the user input 210B) can be processed, using a first machine learning (ML) model, to generate an image understanding of the image 210A. The first prompt derived from the user input 210B can be, for instance, a text prompt that prompts the first ML model to understand (e.g., generate a text description/representation) of a given image) the image 210A. In some implementations, the text representation of the image 210A can include a description of all or major objects present in the image 210A. In some implementations, the text representation of the image 210A can include a location description indicating a location for each of the objects (or the source object) present in the image 210A. For example, in some implementations, the user input 210B can include a source object (e.g., dog in FIG. 2A) in the image 210A to be edited. In this case, the location description can indicate a location of the source object in the image 210A (without identifying locations for all objects present in the image 210A).

In some implementations, an image mask can be generated based on the location description that indicates the location for the source object (e.g., dog) present in the image 210A. The image mask can, for instance, mask the source object that needs to be edited. Alternatively, the image mask can, for instance, mask all areas of the image 210A except for the source object, where content of the masked area(s) of the image 210A can be preserved (e.g., not modified) during processing of the image 210A to generate an edited image (e.g., 220B in FIG. 2B) that has a background visually the same as, or similar to, the image 210A (e.g., also referred to as “source image”). Techniques described in the present disclosure allows automatic generation of such image mask, without a user manually defining a mask area of the image mask, which can be time-consuming and requires accurate definition of the mask area from a human user.

Optionally, referring to FIG. 2C, the automatically generated image mask (e.g., 230) can be rendered to the user via the user interface 200 of the chat application to receive user confirmation. For instance, a prompt 210C (e.g., “Confirm image mask outlined by the dashed line?”) can be rendered to seek user input to confirm (or modify) the position of the automatically generated image mask. Generation of the edited image utilizing the automatically generated image mask can be performed in response to receiving user confirmation of the automatically generated image mask 230. In some implementations, the user can modify the automatically generated image mask and provide the user confirmation after modifying the automatically generated image mask.

By automatically generating the image mask 230, the issue that image mask creation or modification is hardly provided within a chat interface (e.g., 200) is addressed, and computational resources and network resources associated with a user repeatedly trying different image masks and using the different image masks to generate or edit an image can be saved or reduced.

In some implementations, the first ML model can be an image understanding model, such as an object classification and recognition model trained to classify object(s) present in a given image. In some implementations, the image understanding model can be a visual language model (e.g., 191 in FIG. 1B) that detects object(s) in a given image based on comparing an image embedding of the given image and text embeddings of one or more predefined objects in a latent space. In some implementations, the image understanding model can be an image captioning model, a YOLO model, or other applicable model trained to generate a text representation for an image.

Continuing with the non-limiting example above, the text representation for the image 210A can be a description of all objects present in the image 210A, such as “The image depicts a dog riding a bike in a country road, with clouds and mountains in the background”. The text representation for the image 210A can also include location information of the objects (all or only the source object) present in the image 210A, such as “The image depicts a dog riding a bike in a country road, with clouds and mountains in the back, a location of the dog is indicated by . . . ”.

In some implementations, a second prompt can be generated based on the text representation for the image 210A and/or the user input 210B. The second prompt can include an instruction to generate one or more image editing instructions based on a given text (e.g., the text representation of the image 210A). In some implementations, the second prompt can include an additional instruction to generate a text reply to the user input 210B. The second prompt can be processed, for instance, a large language model (“LLM”) configured for text generation, to generate the one or more image editing instructions for image 210A. Continuing with the non-limiting example above, the second prompt can be, for instance, “generate image editing instruction(s) for the image 210A, considering the user input 210B”, or “generate image editing instruction(s) for the image 210A, considering the user input 210B. also generate a text reply to the user input 210B”. In this example, the one or more image editing instructions can be, for instance, “given the image 210A and using the image mask masking all regions of the image 210A except for the source object, replace the source object in the image 210A with the target object”. The text reply (e.g., 220A in FIG. 2B) can be, for instance, “check out the edited image below”, “Here you are, a cat riding a bike”, etc.

In some implementations, the one or more image editing instructions and the image 210A can be processed as input, using a second machine learning (ML) model, to generate an edited image (e.g., 220B in FIG. 2B). The second ML model can be, for instance, an image-generation model trained to generate image(s) based on text descriptions. Continuing with the non-limiting example above, the edited image 220B can have same background as the source image 210A, except for the source object of “dog” being replaced with the target object of “cat”. In other words, the edited image 220B can show a cat riding a bike in a country road, with a background of mountains and/or clouds, where object(s) (e.g., clouds, mountains, bike, country road) in the edited image 220B that are not the target object (e.g., cat) are the same as those in the source image 210A.

In some implementations, referring to FIG. 2B, the edited image 220B and the text reply 220A can be rendered in response to the user input 210B. Optionally, as shown in FIG. 2B, one or more selectable graphical user interface (GUI) elements 221 can be rendered relative to the edited image 220B. The one or more selectable GUI elements 221 can include, for instance, a first GUI element 221a to receive positive user feedback for the edited image 220B. Additionally, or alternatively, the one or more selectable GUI elements 221 can include, for instance, a second GUI element 221b to receive negative user feedback for the edited image 220B. Additionally, or alternatively, the one or more selectable GUI elements 221 can include, for instance, a second GUI element 221c to receive user selection to download the edited image 220B.

In some implementations, one or more training instances can be generated based on the image 210A, the user query 210B, the edited image 220B, and the user feedback (e.g., 221a or 221b). The one or more training instances can be applied to train one or more ML models (e.g., the multi-modal LLM 195B in FIG. 1D) via, for instance, reinforcement learning from human feedback (RLHF).

It is noted that FIGS. 2A and 2B are provided as non-limiting examples of the present disclosure. For instance, in some implementations, the image 210A may depict a boat in an ocean instead of depicting a dog riding a bike, and the use input 210B may be “add a lotus to the pond”. In this case, the image-editing system can determine that the user input 210B is not associated with the image 210A. In response to determining that the user input 210B is not associated with the image 210A, the image-editing system can determine to generate a new image using the user input 210B (without using the image 210A), instead of generating an edited image (e.g., 220B) using both the user input 210B and the image 210A.

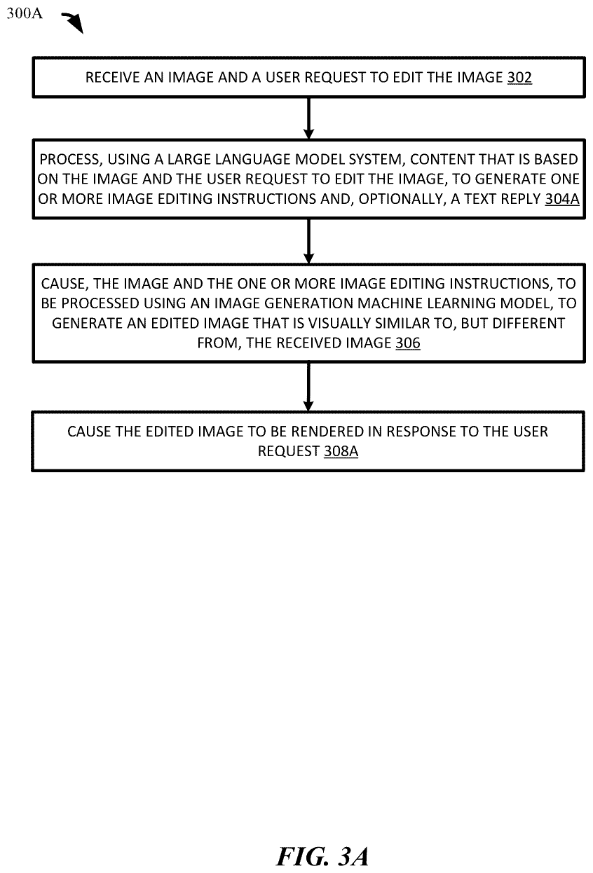

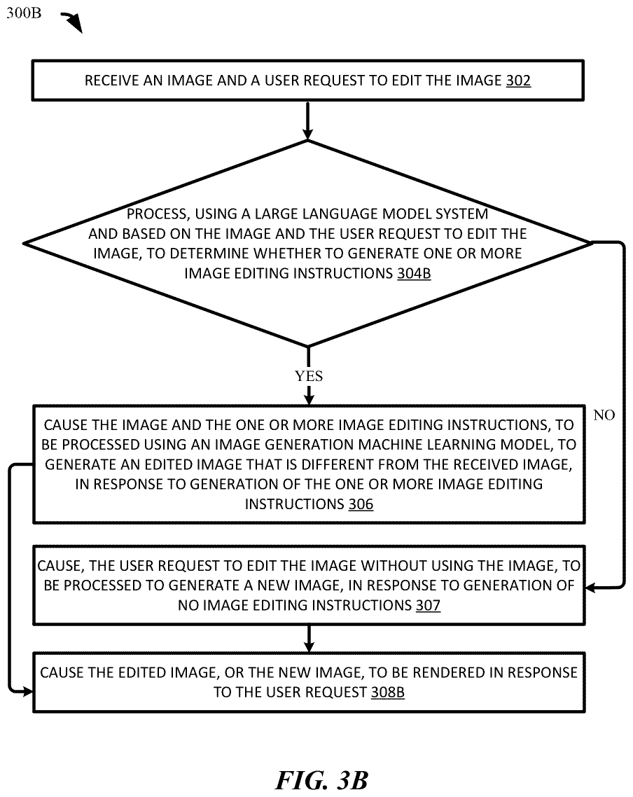

In some implementations, as described previously, the image 210A and the user input 210B can be processed as input, using a multi-modal LLM, to generate the one or more image editing instructions and/or the text reply to the user input 210B. In some of these implementations, the one or more image editing instructions generated using the multi-modal LLM and/or the image 210A can be processed as input, using the image generation model, to generate a model output. Based on the model output of the image generation model, an edited image (e.g., 220B in FIG. 2B) can be derived, or a new image (using only the one or more image editing instructions generated using the multi-modal LLM) can be derived. FIG. 3A illustrates an example method 300A of generating an edited image, in accordance with various implementations of the present disclosure. For convenience, the operations of the flow chart are described with reference to a system that performs the operations. This system can include various components of various computer systems, such as one or more components of server computing device(s). Moreover, while operations of method 300A are shown in a particular order, this is not meant to be limiting. One or more operations can be reordered, omitted or added.

At block 302, the system receives a user request to edit an image.

At block 304A, the system processes, using a large language model system and based on the image and the user request to edit the image, to generate one or more image editing instructions (and/or a text reply). In some implementations, the one or more image editing instructions at least indicates a region of the image to be masked. In some implementations, the region of the image to be masked can be determined based on a source object in the image that is to be replaced with a target object identified in the user request to edit the image. The text reply can be in response to the user request to edit the image.

At block 306, the system causes content based on the image and the one or more image editing instructions to be processed using an image generation machine learning model to generate an edited image that is visually similar to but different from the received image. In some implementations, the edited image includes content of the region of the image that has been masked and additional content consistent with the user request. In some implementations, the additional content in the edited image can include the target object identified in the user request to edit the received image.

At block 308A, the system causes the edited image to be rendered in response to the user request.

In some implementations, the large language model system includes a multi-modal large language model.

In some implementations, the large language model system includes a visual language model or a classification model. In some of these implementations, processing, based on the image and the user request to edit the image, to generate the one or more image editing instructions can include: generating a first text prompt based on the user request to edit the image, and processing the image and the first text prompt, using the visual language model or the classification model, to generate a text representation of the image. The text representation can include, for instance, a description of object(s) present in the received image and/or location information of one or more source objects, of the object(s) present in the received image, that needs to be replaced or modified. In some of these implementations, the large language model system further includes a large language model (LLM). In some of these implementations, processing, based on the image and the user request to edit the image, to generate the one or more image editing instructions can include: processing a second text prompt, using the large language model, to generate the one or more image editing instructions. The second text prompt can be based on the text representation of the image, and can include an instruction to generate the one or more image editing instructions.

In some implementations, the user request may not explicitly identify specific content (e.g., a source object) of the image to be replaced with the additional content (e.g., a target object). In some implementations, the edited image includes content of the region of the image that has been masked.

FIG. 3B illustrates an example method 300B of generating an edited image, in accordance with various implementations of the present disclosure. For convenience, the operations of the flow chart are described with reference to a system that performs the operations. This system can include various components of various computer systems, such as one or more components of server computing device(s). Moreover, while operations of method 300B are shown in a particular order, this is not meant to be limiting. One or more operations can be reordered, omitted or added.

At block 302, the system receives an image and a user request to edit the image.

At block 304B, the system processes, using a large language model system and based on the image and the user request to edit the image, to determine whether to generate one or more image editing instructions (or to generate one or more image generation instructions). In some implementations, the one or more image editing instructions at least indicates a region of the image to be masked for editing (or for image preservation). In some implementations, the region of the image to be masked can be determined based on a source object in the image that is to be replaced with a target object identified in the user request to edit the image.

At block 306, the system causes content based on the image and the one or more image editing instructions to be processed using an image generation machine learning model to generate an edited image that is different from the received image, in response to generation of the one or more image editing instructions. In some implementations, the edited image includes content of the region of the image that has been masked and additional content consistent with the user request. In some implementations, the additional content in the edited image can include the target object identified in the user request to edit the received image.

At block 307, the system causes the user request to edit the image without using the image to be processed, to generate a new image, in response to generation of no image editing instructions. The new image, unlike the edited image, can share no visual element with the received image.

At block 308B, the system causes the edited image, or the new image, to be rendered in response to the user request.

In some implementations, the large language model system includes a multi-modal large language model.

In some implementations, the large language model system includes a visual language model or a classification model. In some of these implementations, processing, based on the image and the user request to edit the image, to generate the one or more image editing instructions can include: generating a first text prompt based on the user request to edit the image, and processing the image and the first text prompt, using the visual language model or the classification model, to generate a text representation of the image. The text representation can include, for instance, a description of object(s) present in the received image and/or location information of one or more source objects, of the object(s) present in the received image, that needs to be replaced or modified. In some of these implementations, the large language model system further includes a large language model (LLM). In some of these implementations, processing, based on the image and the user request to edit the image, to generate the one or more image editing instructions can include: processing a second text prompt, using the large language model, to generate the one or more image editing instructions. The second text prompt can be based on the text representation of the image, and can include an instruction to generate the one or more image editing instructions.

In some implementations, the user request may not explicitly identify specific content (e.g., a source object) of the image to be replaced with the additional content (e.g., a target object). In some implementations, the edited image includes content of the region of the image that has been masked.

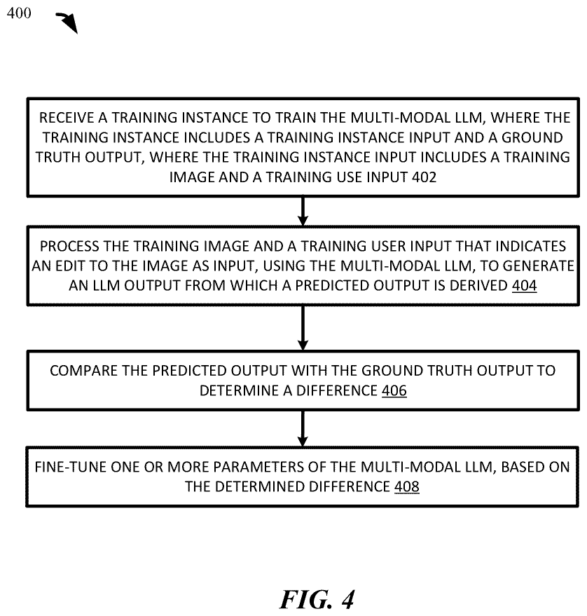

FIG. 4 illustrates an example method 400 of training a multi-modal large language model, in accordance with various implementations of the present disclosure. For convenience, the operations of the flow chart are described with reference to a system that performs the operations. This system can include various components of various computer systems, such as one or more components of server computing device(s). Moreover, while operations of method 400 are shown in a particular order, this is not meant to be limiting. One or more operations can be reordered, omitted or added.

At block 402, the system receives a training instance to train the multi-modal LLM, where the training instance includes a training instance input and a ground truth output. The training instance input can include a training image and a training user input that includes an edit to the image. The ground truth output can include one or more manually curated image editing instructions. The one or more manually curated image editing instructions can indicate, for instance, a target object to present in an edited image and an image mask that masks area(s) of the training image that are not to be modified.

At block 404, the system processes the training image and a training user input that indicates an edit to the image as input, using the multi-modal LLM, to generate an LLM output from which a predicted output is derived.

At block 406, the system compares the predicted output with the ground truth output to determine a difference.

At block 408, the system fine-tunes one or more parameters of the multi-modal LLM, based on the determined difference at block 406.

While FIG. 4 is provided as an example of supervised learning, other methods (e.g., reinforcement learning) may be applied to train the multi-modal LLM, or other machine learning models. For instance, reinforcement learning via human feedback (“RLHF”) can be applied to train the multi-modal LLM (e.g., 195B in FIG. 1E), the first LLM (e.g., 195A in FIG. 1C), to incorporate human feedback into the training of the LLM to align output of such LLM(s) with human preferences, e.g., desired content to be included in the one or more image editing instructions and/or the text reply as described above. This can be implemented using a reward model trained based on human feedback. For instance, for a given user input (e.g., a source image and/or a user request to edit the source image) and a plurality set of image editing instruction(s) can be determined, and a human reviewer can indicate a preference (e.g., in the form of a scalar score) for each set of the plurality of image editing instruction(s). In other words, the plurality set of image editing instruction(s) can be ranked in an order from highest human preference (indicated by a highest scalar score) to lowest human preference (indicated by a lowest scalar score). In some implementations, the scalar scores assigned by the human reviewer to the plurality set of image editing instruction(s) can satisfy a Gaussian distribution with an average value of approximately “0”, where the scalar score(s) for response(s) of higher human preference should be positive and increase with the increasing of human preference and the scalar score(s) for response(s) of lower human preference should be negative and decreases with the decreasing of human preference.

The scalar score can be applied as a reward in the RLHF process, where a large value of the scalar score indicates a higher quality of a corresponding set of image editing instruction(s) more preferred by the human reviewer and a lower value of the scalar score indicates a higher quality of a corresponding set of image editing instruction(s) that is less preferred by the human reviewer. In some implementations, such given user input and the plurality set of image editing instruction(s) can be stored in the data storage 106 (or the storage 129) as one instance for training the reward model. In some implementations, a small quantity of instances can be manually curated and/or stored in the data storage 106, to train the reward model.

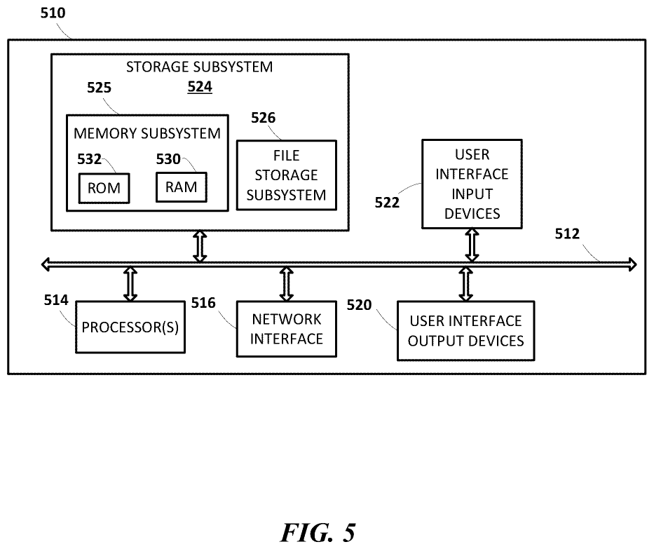

FIG. 5 is a block diagram of an example computing device 510 that can optionally be utilized to perform one or more aspects of techniques described herein. For example, all or aspects of computing device 510 can be incorporated in server(s) or other computing device(s) that are utilized to implement prompt-to-prompt editing techniques disclosed herein.

Computing device 510 typically includes at least one processor 514 which communicates with a number of peripheral devices via bus subsystem 512. These peripheral devices can include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 can include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 can include the logic to perform selected aspects of the methods of FIGS. 3A, 3B, and/or 4, as well as to implement various components described herein.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem can use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

While several implementations have been described and illustrated herein, a variety of other means and/or structures for performing the function and/or obtaining the results and/or one or more of the advantages described herein can be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations can be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented using one or more processors is provided. The method includes: receiving an image and a user request to edit the image; processing, using a large language model system, content that is based on the image and the user request to edit the image, to generate one or more image editing instructions, the one or more image editing instructions indicate a particular region of the image to be edited; and causing the image and the one or more image editing instructions to be processed, using a machine learning model, to generate an edited image that includes image content from the image that is not within the particular region. The edited image further includes, in the particular region, target image content that is consistent with the user request to edit the image

These and other implementations of the technology disclosed herein can include one or more of the following features.

In some implementations, the user request to edit the image does not specify the region of the image to be masked.

In some implementations, the one or more image editing instructions further indicate the target image content to replace the image content from the image in the particular region.

In some implementations, the target image content in the particular region of the edited image includes a target object specified by the user request to edit the image. In some implementations, the user request to edit the image identifies a source object in the image content in the particular region of the image to be replaced with the target object. In some implementations, the user request to edit the image does not identify a source object in the image content in the particular region of the image to be replaced with the target object.

In some implementations, the large language model system includes a multi-modal large language model. in this case, processing the content that is based on the image and the user request to edit the image, to generate the one or more image editing instructions can include: processing, using the multi-modal large language model, pixels of the image and user request content that is based on the user request, to generate output, of the multi-modal large language model, that indicates the one or more image editing instructions.

In some implementations, the large language model system includes a visual language model. In this case, processing the content that is based on the image and the user request to edit the image, to generate the one or more image editing instructions can include: generating a text prompt based on the user request to edit the image; and processing the image and the text prompt, using the visual language model, to generate a text representation of the image that describes one or more objects in the image.

In some implementations, the text representation of the image further indicates location information of the one or more objects in the image, or location information of a source object in the image to be edited based on the user request to edit the image.

In some implementations, the large language model system further includes a large language model. In some implementations, processing the content that is based on the image and the user request to edit the image, to generate the one or more image editing instructions can include: processing the text representation of the image and user request content that is based on the user request, using the large language model, to generate the one or more image editing instructions.

In some implementations, the large language model system includes an object classification model or an image captioning model. In some implementations, processing the content that is based on the image and the user request to edit the image, to generate the one or more image editing instructions can include: processing the image, using the object classification model or the image captioning model, to generate a model output from which one or more classification labels and/or positions of the one or more classification labels are determined; and generating a text representation of the image based on the one or more classification labels and/or positions of the one or more classification labels are determined.

Various implementations of the present disclosure provides another method implemented using one or more processors, the method include: receiving a first user request to edit a first source image; processing content that is based on the first source image and that is based on the first user request to edit the first source image, to generate a first set of image processing instructions, the one or more image processing instructions including an image editing instruction to edit the first source image into an edited image using the first source image; processing the first source image and the first set of image processing instructions that includes the first image editing instruction, using a machine learning model, to generate a first model output from which an edited image is derived; receiving a second user request to edit a second source image; processing content that is based on the second source image and that is based on the second user request to edit the second source image, to generate a second set of image processing instructions, the second set of image processing instructions including an image generation instruction to generate a new image without using the second source image; processing the second set of image processing instructions that includes the image generation instruction, using the machine learning model or another machine learning model, to generate a second model output from which the new mage is derived.

Various implementations of the present disclosure provides a method including: receiving a user request to edit an image; processing the image to generate a textual description of the image that describes one or more objects in the image and positions of the one or more objects in the image; processing, using a large language model, the user request and the textual description of the image, to generate one or more image editing instructions; and causing the image and the one or more image editing instructions to be processed, using an image generation machine learning model, to generate an edited version of the image that includes one or more edits that are based on the user request.

In some of the various implementations, the large language model is a multi-modal large language model, and processing the content that is based on the image and the user request to edit the image, to generate the one or more image editing instructions can include: processing, using the multi-modal large language model, pixels of the image and user request content that is based on the user request, to generate output, of the multi-modal large language model, that indicates the one or more image editing instructions.

In some of the various implementations, processing the image to generate the textual description is performed using an object detection and classification model. In some of the various implementations, processing the image to generate the textual description is performed using an image captioning model. In some of the various implementations, processing the image to generate the textual description is performed using a visual language model.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations can include a system of one or more computers that include one or more processors operable to execute stored instructions to perform a method such as one or more of the methods described herein.

We claim:

1. A method implemented using one or more processors, the method comprising:
receiving an image and a user request to edit the image;
processing, using a large language model system, content that is based on the image and the user request to edit the image, to generate one or more image editing instructions,
wherein the one or more image editing instructions indicate a particular region of the image to be edited; and
causing the image and the one or more image editing instructions to be processed, using a machine learning model, to generate an edited image that includes image content from the image that is not within the particular region,
wherein the edited image further includes, in the particular region, target image content that is consistent with the user request to edit the image.

2. The method of claim 1, wherein the user request to edit the image does not specify the region of the image to be masked.

3. The method of claim 1, wherein the one or more image editing instructions further indicate the target image content to replace the image content from the image in the particular region.

4. The method of claim 1, wherein the target image content in the particular region of the edited image includes a target object specified by the user request to edit the image.

5. The method of claim 4, wherein the user request to edit the image identifies a source object in the image content in the particular region of the image to be replaced with the target object.

6. The method of claim 4, wherein the user request to edit the image does not identify a source object in the image content in the particular region of the image to be replaced with the target object.

7. The method of claim 1, wherein the large language model system includes a multi-modal large language model and wherein processing the content that is based on the image and the user request to edit the image, to generate the one or more image editing instructions comprises:
processing, using the multi-modal large language model, pixels of the image and user request content that is based on the user request, to generate output, of the multi-modal large language model, that indicates the one or more image editing instructions.

8. The method of claim 1, wherein the large language model system includes a visual language model.

9. The method of claim 8, wherein processing the content that is based on the image and the user request to edit the image, to generate the one or more image editing instructions comprises:
generating a text prompt based on the user request to edit the image, and
processing the image and the text prompt, using the visual language model, to generate a text representation of the image that describes one or more objects in the image.

10. The method of claim 9, wherein the text representation of the image further indicates location information of the one or more objects in the image, or location information of a source object in the image to be edited based on the user request to edit the image.

11. The method of claim 8, wherein the large language model system further includes a large language model.

12. The method of claim 11, wherein processing the content that is based on the image and the user request to edit the image, to generate the one or more image editing instructions comprises:
processing the text representation of the image and user request content that is based on the user request, using the large language model, to generate the one or more image editing instructions.

13. The method of claim 1, wherein the large language model system includes an object classification model or an image captioning model.

14. The method of claim 13, wherein processing the content that is based on the image and the user request to edit the image, to generate the one or more image editing instructions comprises:
processing the image, using the object classification model or the image captioning model, to generate a model output from which one or more classification labels and/or positions of the one or more classification labels are determined; and
generating a text representation of the image based on the one or more classification labels and/or positions of the one or more classification labels are determined.

15. A method implemented using one or more processors, the method comprising:
receiving a first user request to edit a first source image;
processing content that is based on the first source image and that is based on the first user request to edit the first source image, to generate a first set of image processing instructions, the one or more image processing instructions including an image editing instruction to edit the first source image into an edited image using the first source image;
processing the first source image and the first set of image processing instructions that includes the first image editing instruction, using a machine learning model, to generate a first model output from which an edited image is derived;
receiving a second user request to edit a second source image;
processing content that is based on the second source image and that is based on the second user request to edit the second source image, to generate a second set of image processing instructions, the second set of image processing instructions including an image generation instruction to generate a new image without using the second source image; and
processing the second set of image processing instructions that includes the image generation instruction, using the machine learning model or another machine learning model, to generate a second model output from which the new mage is derived.

16. A method implemented using one or more processors, the method comprising:
receiving a user request to edit an image;
processing the image to generate a textual description of the image that describes one or more objects in the image and positions of the one or more objects in the image;
processing, using a large language model, the user request and the textual description of the image, to generate one or more image editing instructions; and
causing the image and the one or more image editing instructions to be processed, using an image generation machine learning model, to generate an edited version of the image that includes one or more edits that are based on the user request.

17. The method of claim 16, wherein the large language model is a multi-modal large language model and wherein processing the content that is based on the image and the user request to edit the image, to generate the one or more image editing instructions comprises:
processing, using the multi-modal large language model, pixels of the image and user request content that is based on the user request, to generate output, of the multi-modal large language model, that indicates the one or more image editing instructions.

18. The method of claim 16, wherein processing the image to generate the textual description is performed using an object detection and classification model.

19. The method of claim 16, wherein processing the image to generate the textual description is performed using an image captioning model.

20. The method of claim 16, wherein processing the image to generate the textual description is performed using a visual language model.
